(19) United States
(12) Patent Application Publication
(10) Pub. No.: US 2014/0358453 A1
(43) Pub. Date: Dec. 4, 2014

(54) ROBOT REDUCER PREDICTIVE TRENDING

(71) Applicant: Tommy Felton Kirk, Lincoln, AL (US)

(72) Inventor: Tommy Felton Kirk, Lincoln, AL (US)

(73) Assignee: HONDA MOTOR CO., LTD., Tokyo (JP)

(21) Appl. No.: 14/146,398

(22) Filed: Jan. 2, 2014

Related U.S. Application Data
(60) Provisional application No. 61/829,396, filed on May 31, 2013.

(51) Int. Cl. G01M 13/02

(52) U.S. Cl. CPC G01M 13/02
USPC 702/39

(57) ABSTRACT

A system and method for monitoring the status of a robot reducer by performing trend analyses on detected ultrasonic frequencies emitted from the robot reducer during its operation so that preventive maintenance can be performed on the reducer to avoid a failure during operation of the reducer.

### CROSS-REFERENCE TO RELATED APPLICATIONS

This application claims the benefit of U.S. Provisional Application No. 61/829,396, filed May 31, 2013, the entire disclosure of which is hereby incorporated herein by reference.

### BACKGROUND

A robot reducer is a servo motor-driven mechanical gearbox used to articulate the arm(s) of a robot. The reducer is a combination of precision gears and bearings configured to deliver a specific ratio to translate the torque of the motor into a very accurate and repeatable motion. During operation, ultrasonic emissions (noise) are created by metal to metal contact in the reducer. However, robotic arms start, stop, and move as necessary to perform the desired robotic operation, typically in a repetitive, cyclical manner. The motion is normally fluid at speed, but it is typically neither continuous nor circular. This discontinuous operation of the typical repetitive discrete motions of robotic usage has mitigated against monitoring of the ultrasonic noise to examine the condition of the reducer parts.

Nevertheless, monitoring robot reducers to predict potential failures is important due to the expense of losing a reducer during production, potentially leading to undesirable delays and unnecessary costs (such as due to sidelined resources) in the production process. Depending on the robot, it can take many hours to change a reducer, and due to the high hourly cost of taking a robot out of production, such a failure can cost a substantial amount of money in lost productivity. Accordingly, it would be useful to change the reducers prior to catastrophic failure if such failure could be predicted in advance so that maintenance operations can be scheduled at production down times.

### SUMMARY

This application relates generally to a means of predicting a failure in a robot, and more specifically to monitoring the status of a robot reducer by performing trend analyses on detected ultrasonic frequencies emitted from the robot reducer during its operation so that preventive maintenance can be performed on the reducer to avoid a failure during operation of the reducer.

Provided are a plurality of example embodiments, including, but not limited to, a system for detecting wear in a robot, which may include: a sensor for sensing ultrasonic emissions, the sensor being attached to a housing of the robot; an analyzer for electrically collecting, analyzing, and storing the ultrasonic emissions of the sensor; a storage device for storing the analyzed ultrasonic emissions; and a computer for processing the stored analyzed ultrasonic emissions for use in detecting a trend in a characteristic of the noise emissions (such as an increase in the average amplitude of the noise at a particular frequency or bandwidth). In such a system, the wear on components of the robot can be predicted by using the result of detecting the trend. Maintenance can then be scheduled when a threshold value in the characteristic is met or exceeded.

Also provided in another aspect is a method of detecting wear of components of a robot, with the method including any of the steps of:
sensing the ultrasonic emissions from the components of the robot;
analyzing the ultrasonic emissions;
recording the analyzed ultrasonic emissions;
performing a trend analysis on the recorded ultrasonic emissions;
determining a state of wear of the components from the trend analysis; and
replacing the components when the state of wear of the components is determined to be above a threshold amount.

Further provided is a method of maintaining a robot, with the method including any of the steps of:
detecting a noise signal emitted by the robot;
recording the detected noise signal on a plurality of different dates;
determining amplitude data of the noise signals recorded on different dates;
comparing the amplitude data of the noise signals recorded on the different dates to each other; and
performing a maintenance operation on the robot as a result of the comparing.

Also provided in another aspect is a method of maintaining a robot, with the method including any of the steps of:
attaching an audio sensor to the robot for detecting a ultrasonic noise signal emitted by the robot;
recording the detected ultrasonic noise signal emitted by the robot on a plurality of different dates;
determining an average amplitude of the ultrasonic noise signals recorded on each of the different dates;
comparing the average amplitudes of the noise signals to each other to detect a predetermined threshold difference between the average amplitudes; and
performing a maintenance operation on the robot as a result of detecting the predetermined threshold difference.

Further provided in another aspect is a method of maintaining a robot, with the method including any of the steps of:
attaching an audio sensor to a reducer of the robot for detecting a noise signal emitted by the reducer;
recording the detected noise signal emitted by the reducer on a plurality of different dates;
determining, using a computer, at least one characteristic of each of the noise signals recorded on the different dates;
comparing, using the computer, the least one characteristic of the noise signals recorded on different dates to each other to detect a predetermined threshold difference in the at least one characteristic; and
performing maintenance on the reducer as a result of detecting the predetermined threshold difference.

In addition are provided other aspects of any of the above methods or systems where the predetermined threshold is determined by monitoring at least one characteristic of the noise signals until a critical date at which failure occurs or is about to occur, such that the predetermined threshold is derived from a characteristic of the noise signals that were recorded near or at the critical date.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1A is a block diagram showing an example system for detecting, recording, and analyzing ultrasonic sound emissions (noise) from a robot;

FIG. 1B is a block diagram showing an alternative system for detecting, recording, and analyzing the ultrasonic sound emissions from a robot;

FIG. 2A shows an schematic of example equipment that can be used for performing the methods of the example system of FIG. 1A;

FIG. 2B shows a schematic of an example sensor and FIG. 2C shows a corresponding sensor adapter that is used for the example equipment shown in FIG. 2A;

FIGS. 3A and 3B show examples of spreadsheet data derived from the ultrasonic emissions of the robot from a system such as shown in FIG. 1;

FIG. 4A shows a plot of the derived ultrasonic data from a specific date as contained in a spreadsheet such as the type shown in FIG. 3B;

FIG. 4B shows a plot of the derived ultrasonic data from two different specific dates spread out in time;

FIG. 5 shows a screen shot of example output of software analysis by a system as shown in FIG. 1A showing a plot of the magnitude (in dB) and the logarithm of that magnitude of the ultrasonic frequencies that were recorded over time; and

FIG. 6 is a flow chart showing one example process for monitoring robot reducer wear and replacing worn parts.

### DETAILED DESCRIPTION OF THE EXAMPLE EMBODIMENTS

Trend analysis of robot components can be utilized for monitoring the wear and tear of the operation of the components, and in particular for predicting that a failure of the component is likely in the near future, so that preventive maintenance can be performed prior to any failure. Monitoring sonic or ultrasonic emissions from the components (e.g., the “noise” from the robot operation) over time provides one such means of monitoring the state of such components, and hence can be used for predicting when a failure may be likely to occur in the near-term. In particular, this may be accomplished by monitoring the ultrasonic emissions over time and performing a trend analysis on the ultrasonic emissions to detect increases in the emissions that show increasing wear and tear.

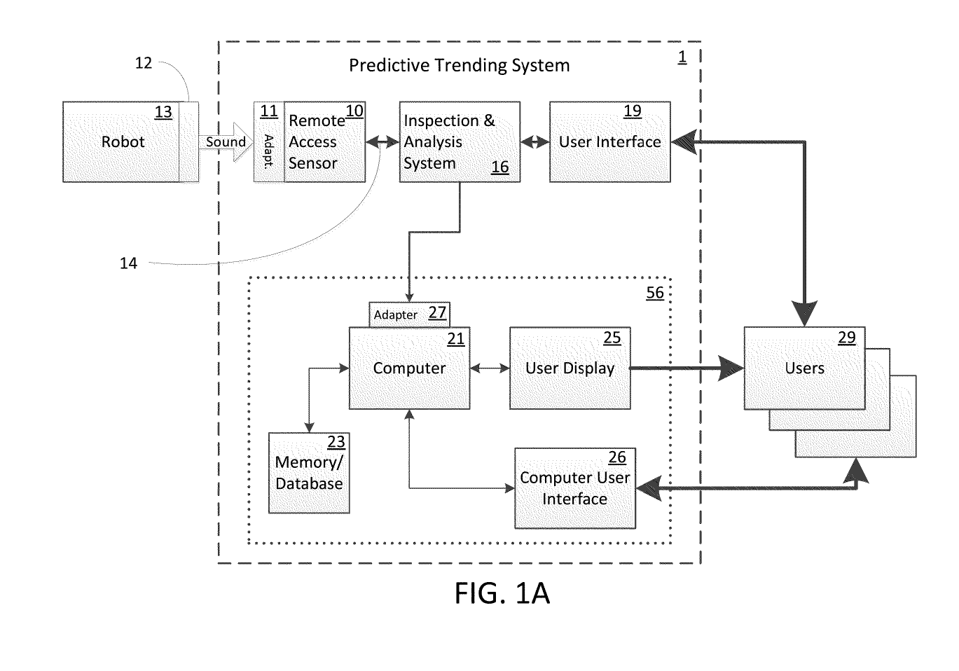

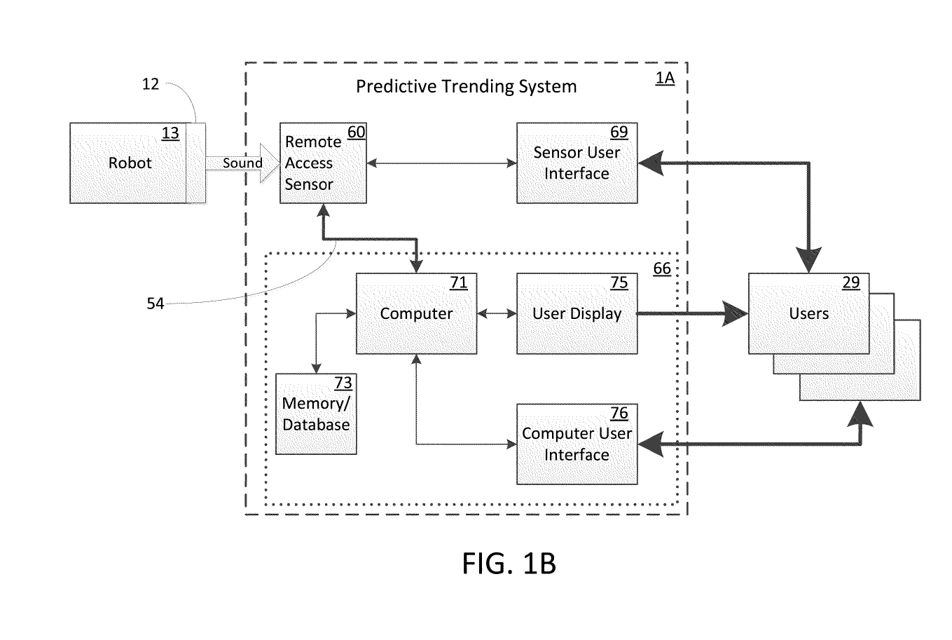

FIG. 1A shows an example arrangement of an example system 1 that can be used to monitor the sonic or ultrasonic emissions (noise signals) from a robot 13, in this case from a robot reducer 12 of the robot 13. One or more audio sensors or remote access sensors (RAS) 10 for detecting ultrasonic emissions (i.e., the “noise” signals generated by the transducer components during operation) are attached to, or provided in close proximity to, the housing of the robot reducer 12 (or another component of the robot to be monitored). For example, the RAS 10 can be attached directly to the reducer housing an existing fitting or port (such as a grease port) by using an adapter 11, or it may be connected to a bolt or other fastener used to connect portions of the housing, or the RAS 10 may be placed sufficiently close to the housing to detect the desired ultrasonic emissions without direct contact. In most cases, direct connection of the RAS 10 to the housing of the reducer 12 via the adapter 11 will provide a better means of detecting the sonic emissions as compared to more indirect means.

Each RAS 10 is connected, via a connection cable 14, to an inspection and analysis system 16 for recording and analyzing the detected ultrasonic emissions (noise) and for saving the data as an audio or sound file (e.g., wave or .wav file). The inspection and analysis system 16 stores the files on a removable flash card, although other storage means could be utilized as desired. In one embodiment, a sonic monitoring device, such as a commercially available Ultraprobe 10,000 ultrasonic detection instrument (provided by UE Systems Inc.), can be used as part of the inspection and analysis system. The system 1 includes a user interface 19 to the inspection and analysis system 16 to allow a user to interact with the system and customize the sonic monitoring, where desirable. For example, the user interface 19 can be provided on a probe device that provides the inspection and analysis system 16. An interface for attaching headphones can also be provided as a user interface to allow the user to monitor the audible sound being emitted by the robot 13. The inspection and analysis system 16 might also incorporate a user display.

The stored data can also be provided in a form that can be transferred to another computing device 56 to support further analysis, such as by using a programmable computer 21 with a corresponding storage device 23 (e.g., memory or database) for analysis purposes. For example, the data (i.e., sound files) recorded by the inspection and analysis system 16 could be transferred to the computer 21 as wave files. Such wave data can be analyzed by using software and which, if desired, could be converted into data that can be imported into another application, such as a spreadsheet application to provide further analysis and data presentation. The data can be transferred to the computer 21 directly from the flash card storing the wave files, such as by using a CF to USB adapter 27. The system 1 includes a user interface to the computer 21, such as a keyboard, mouse, touchscreen, trackball, or other user interface, or combination thereof, to accept user commands and allow customization for further analysis. The system also includes a user display 25 to display information (such as plots and spreadsheets) to one or more users 29.

FIG. 1B shows another example arrangement of a system 1A as an alternative to system 1 that can be used to monitor the ultrasonic emissions from the robot reducer 12 of the robot 13 using a more generalized setup. One or more remote access sensors (RAS) 60 for detecting the ultrasonic emissions are attached to, or provided in close proximity with, the housing of the reducer 12, such as in a similar manner as described above for system 1. Each RAS 60 can be directly connected, via a connection cable 54, to an analysis system 66, for recording and analyzing the detected ultrasonic emissions, such as by using a programmable computer 71 and storage device 73. The system 1A includes a user interface 76, such as a keyboard, mouse, touchscreen, trackball, or other interface, or combination thereof, to accept user commands. The system also includes a user display 75 to display information to one or more of the users 29. Such a system 1A may also have a separate sensor user interface 69, if desired, although a more generalized embodiment could utilize the computer user interface 76 for all user interface functions with the users 29.

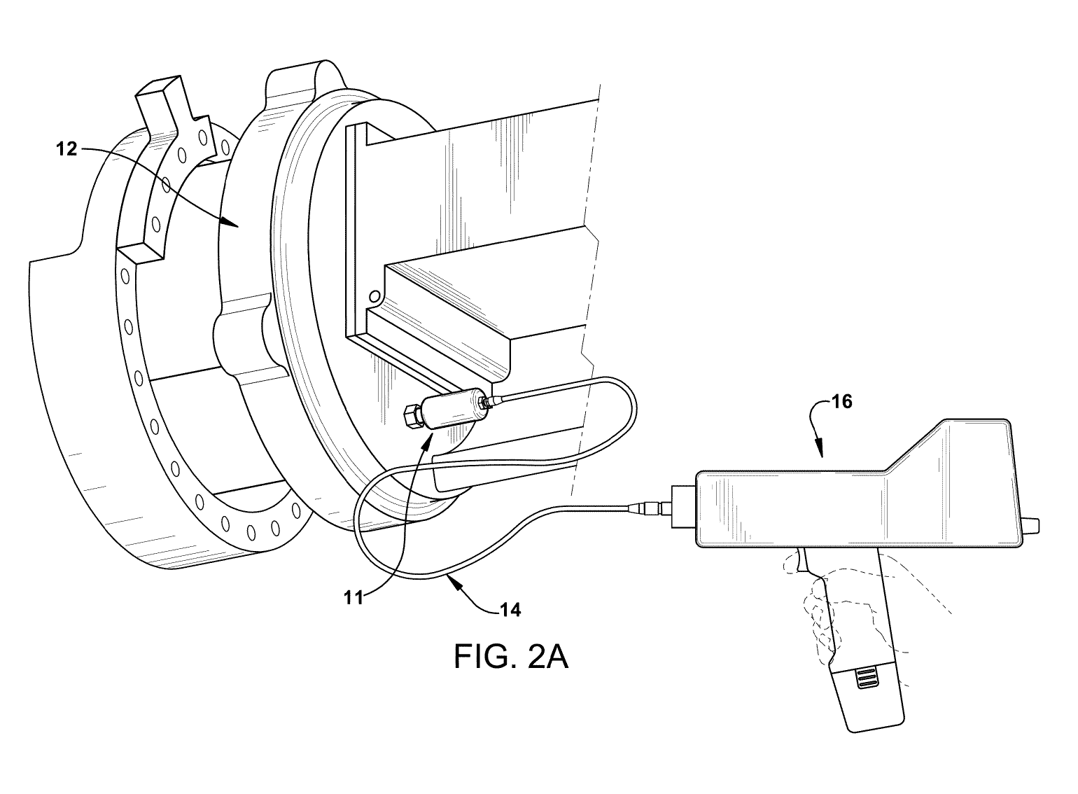

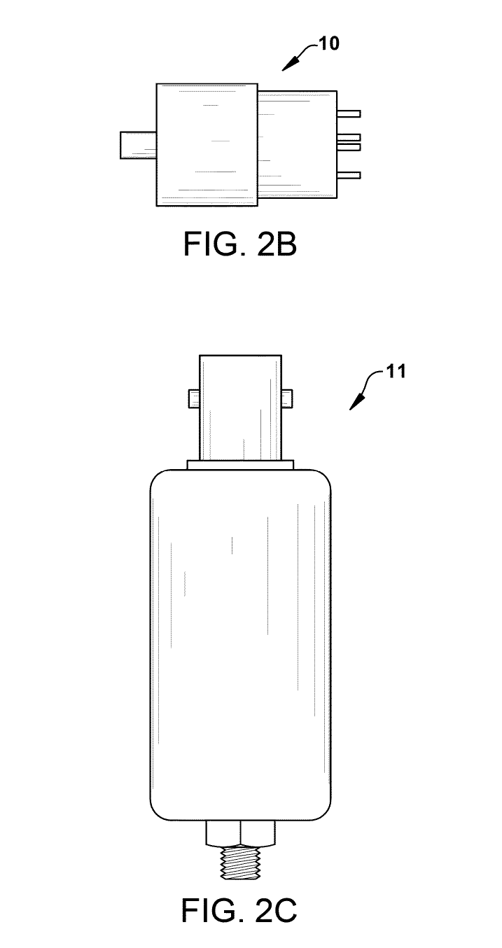

FIG. 2A shows an example physical arrangement of the inspection and analysis system 16 of system 1 such as shown in FIG. 1A including an RAS sensor (not shown) in a customized adaptor 11 and a cable 14 connected to a robot transducer 12. In this case, the example adaptor 11 is mounted on the housing of the example robot transducer 12 with the RAS sensor contained within the adaptor 11. The adapter 11, for example, can be made compatible with an existing grease port by providing female threads to connect to the male threads of the grease port. Other adaptor designs can be used for other robots or different connection options.

FIG. 2B shows an example of the RAS sensor 10 and FIG. 2C shows an example the corresponding adaptor 11 used with the sensor 10, both for use with the example setup of FIG. 2A to implement the example embodiment system 1 of FIG. 1A.

For any of the example embodiments, the RAS sensor will typically be configured to detect sonic emissions (noise) generated by the operation of the robot reducer for monitoring the robot operation. For example, the sonic emissions of the robot can be collected for conversion into data that is stored as audio files. Such files may be analyzed by the analysis system, where changes, trends, and other features of the noise may be monitored and further analyzed. Generally, the sonic emanations of the robot being monitored are ultrasonic (i.e., above the frequency of human hearing), but audio frequencies and even subsonic frequencies could be monitored as well, or alternatively, if desired. Generally, for the disclosed example of monitoring the robot reducer, the desirable frequency of the noise emanations to be monitored fall around a standard mechanical frequency of about 30 kHz within some narrow bandwidth (such as within a few kHz, for example). For the example process, the amplitudes of the noise emissions at that frequency are of interest.

Accordingly, the stored audio file can be analyzed using analysis software, such as a commercially available Spectralyzer software (provided by UE Systems Inc.), which takes each wave file, “plays” it, and generates data (i.e., amplitudes at the desired frequency) that can be used to display raw data (e.g., such as in an Excel spreadsheet) and a waveform. For convenience, the data can be converted into a decibel level. In the case of the example system 1 of FIG. 1A, the computer 21 executes the analysis software to analyze the wave files recorded and transferred from the inspection and analysis system 16 to the computer 21, upon which the analysis software is executing.

As an alternative, customized software can be developed that could automate many of these processes, so that the end result of such an alternative may bypass the display of intermediate data, and merely show the trend results and notify the user (or robot operator), when the maintenance threshold has been reached. The computer system of such an alternative system may even automatically schedule the maintenance activity at an optimum time and date. Such a system might use the example setup shown in FIG. 1B, for example, or an alternative setup.

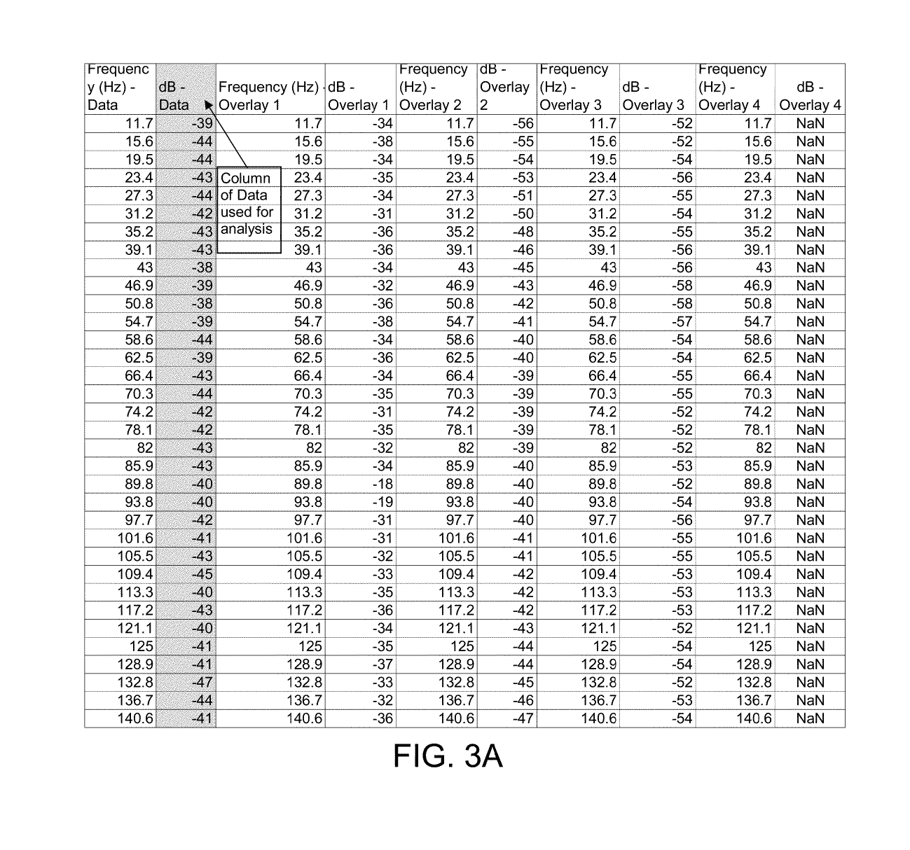

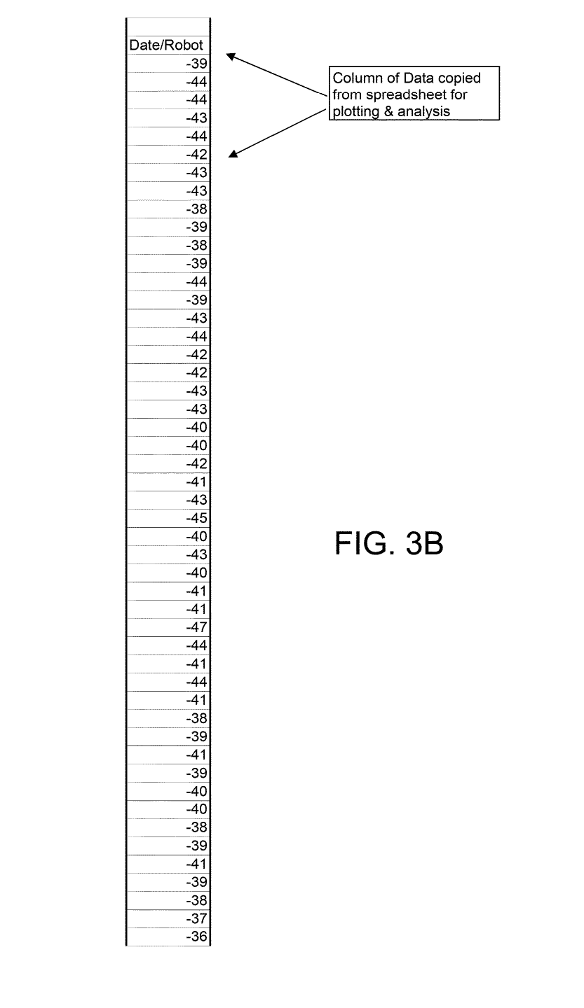

Returning to the Example system 1 as shown in FIG. 1A, the analysis software analyzes the stored noise data and provides the ability to export the data to other software, such as providing a format for creating spreadsheets, in decibel form, for displaying trends over time. In this manner, the noise emissions of various dates can be compared. FIGS. 3A and 3B show various stages of this process, showing examples of spreadsheet tables using example data of noise amplitudes taken at the desired frequencies. The example spreadsheet shown in FIG. 3A is created in the example system 1 by the analysis software (executing on computer 21) by playing on the computer 21 the sound data that was previously recorded by the inspection and analysis system 16 using sensor 10. The analysis software executing on the computer 21 creates a spreadsheet such as shown in FIG. 3A with a temporary filename, and also allows several format options. For example, each time a robot is checked, a file is created according to the robot and date checked. The, a column of data such as shown in FIG. 3B can be used to generate data plots showing the noise levels for the given date. This data can also be analyzed over time to find trends in the noise levels, as further described below.

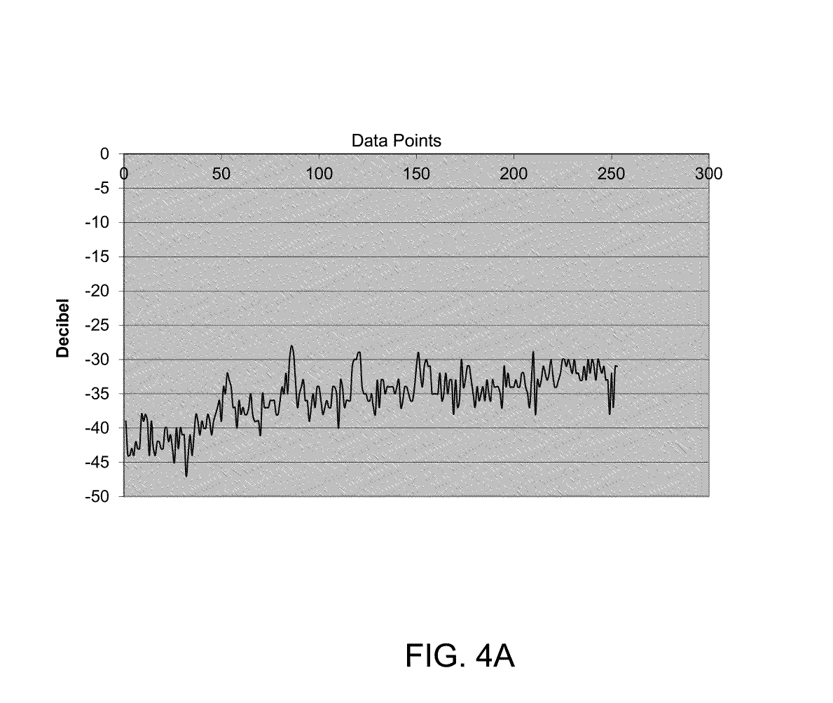

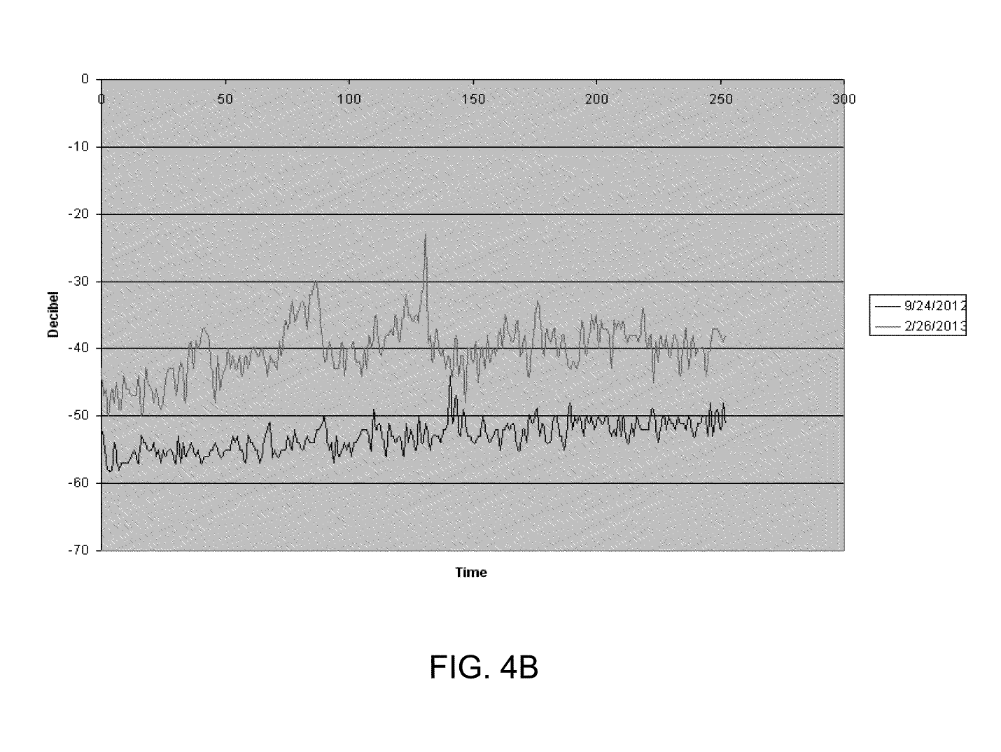

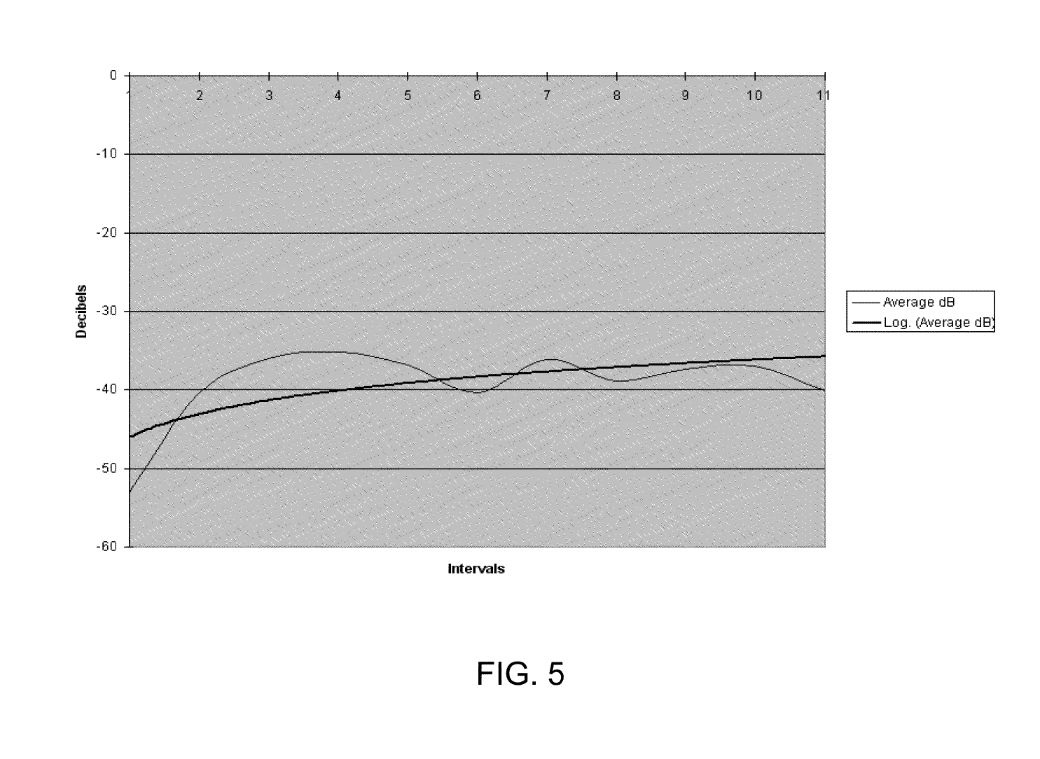

Hence, as the parts wear in the robot reducer (or in other monitored robot parts), the noise generated by the reducer (or other part(s)) and recorded by the example system will undergo changes that can be monitored and properly responded to. FIG. 4A shows an example plot of the amplitudes (in dB) of the desired frequency taken from recordings taken for a single example date, whereas FIG. 4B shows an example plot of amplitude data taken on two different dates to show the changes in response on those different dates. FIG. 5 shows a trend plot of an average power level of the monitored emissions over time in both decibels (dB) and a logarithm of the result, showing a trend of the increasing noise power output as the parts of the reducer wear. This approach can be used to detect when a predetermined threshold, determined as described hereinbelow, is being approached or has been reached to trigger a desired response.

For implementing the example approach discussed herein, many of the steps can be manually performed. For example, the user can manually start and stop the recording process, and the wave files can be manually transferred to the computer 21, with the analysis software being operated by an operator, and the spreadsheet being loaded by an operator. Furthermore, the operator can use analysis software to create the average trend plots. Finally, the operator can determine when the threshold is met and the maintenance operation can be manually scheduled. However, may or all of these steps can be automated as well to improve productivity and reduce reliance upon human operators, where desired.

For at least one example application, a number of the robots are welding robots, each one of which is programmed to follow a specific path. For example, if a robot is welding a door on a vehicle, it makes the same welds, in the same order, over and over again. In an effort to be consistent, part of the methodology is to start recording when the robot begins a motion, and then stop recording when the robot ends a motion, to capture an entire cycle of motion. For the reducer component found on such robots, maintenance operations are particularly useful to avoid down time. Alternatively the robots may be monitored continuously, where desired, or the robots may be monitored periodically, such as after maintenance operations (such as greasing) or other events. Generally, continuous monitoring is useful for keeping close track of the wear on the robot and one or more of its parts. Other components other than robot reducers might also or alternatively be monitored.

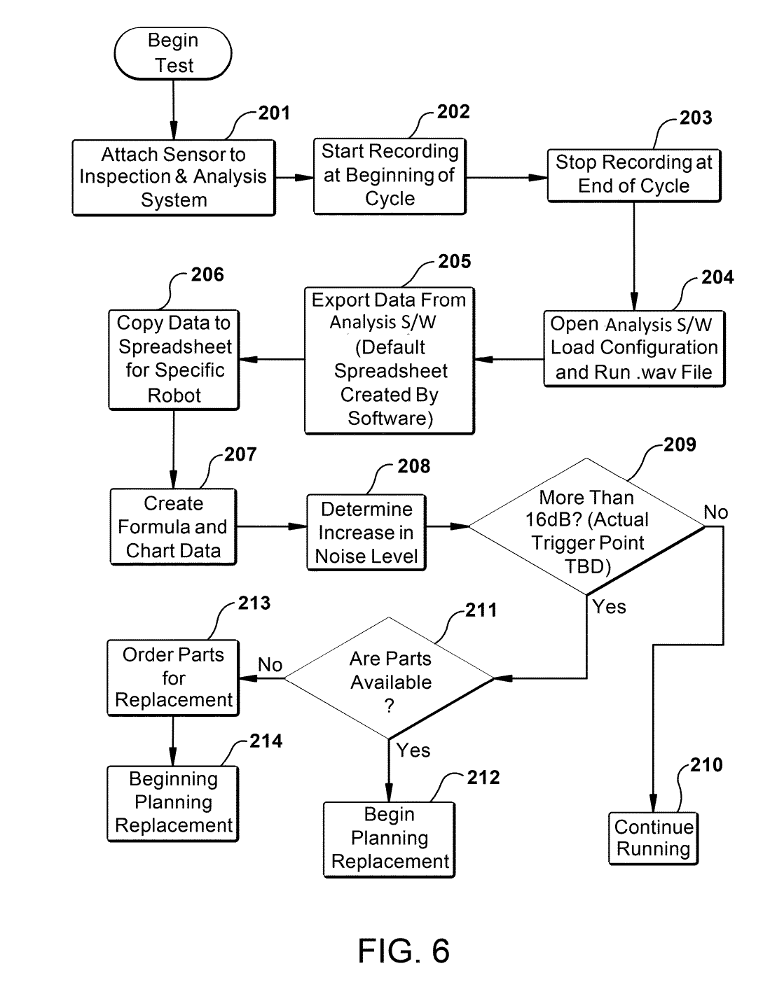

FIG. 6 is a flow chart of one example of the monitoring processes that can use the example system 1 described above. To run a test, the RAS sensor, which is attached to the robot being monitored, is attached by a cable to the inspection and analysis system 201 to detect and monitor the noise emanations of the robot. Typically, the audio recording is started at the start of a cycle 202. The recording is stopped at the end of a cycle 203, resulting in a saved audio file, in this case a .wav file. The analysis software running on a computer loads the proper configuration file and runs the .wav file 204 for analyzing the data, ultimately exporting data 205 to a spreadsheet 206 running on the computer, where chart data are created 207 to show the trends. The trends are analyzed to determine whether and how much the noise level has increased 208 and the noise level is compared to a predetermined threshold increase value (e.g., >16 dB) 209. If the increase threshold is not met, the process will continue with another cycle 210 (which may be at a later scheduled time or on another date). The process can be continued over many weeks, months, or years, regularly monitoring the status of the robot over time to monitor the wear and tear of one or various parts of the robot.

However, if the threshold is exceeded, the preventive maintenance process is begun. It is determined whether replacement parts are available 211, and if so, the replacement process is planned 212, such as during a scheduled maintenance period. If parts are not available, parts are ordered 213, and then the replacement process is planned 214 based on the availability of the parts. After replacement, there may be some gap in monitoring, but the entire process begins again at some point to monitor the repaired robot. As an alternative, a plurality of thresholds might be used, with some thresholds leading to an inspection process, and other thresholds leading to preventive maintenance by replacing and/or repairing parts. Various parts of the robot could be monitored in this manner, although monitoring the reducer is of particular interest.

As described above, many of these steps can be manually performed, or they can be automated by using a programmed computer, for example.

As a preliminary matter for any given application, it must be determined how the trending analysis correlates to the wearing of the parts, so that target values can be chosen in order to decide when to replace the parts prior to an actual failure, but not so soon that parts are prematurely replaced. Clearly, this is a tradeoff that requires determining objective criteria (that may include subjective decisions) as to at which point replacement should occur. For any particular application, monitoring can be performed until a failure results, or inspections may be utilized to correlate recorded values with actual wear and tear. It may take may such trials in order to optimize the choice of the threshold value(s), which would typically be chosen so that maintenance is performed sufficiently before the expected point of failure in order to avoid failure during operation of the robot, so that maintenance can be scheduled during shutdowns or slow periods of operation.

Once it has been determined where the proper wear thresholds should be (such as through trial-and-error testing, or by using analysis, or both), then a process can be implemented to monitor the robots over time in order to perform predictive maintenance and replacement during down times to avoid failures. FIG. 6 described above provides an example of such a process. Over time, the threshold can be updated based on this monitoring process and the actual wear and tear observed on the parts, leading to a more optimum process.

For example, in the case of monitoring robot reducers, establishing a baseline reading on each reducer, taking readings from the reducer at intervals over time, and trending the exported data in excel, the analyst can “see” the reducer getting louder, (wearing out) using the results of the disclosed method. As the wear progresses, the analyst can make a judgment as to when to replace the reducer based on the delta decibel level (e.g., when the threshold has been met or exceeded). The baseline readings can be established using the first reading at each robot being monitored, with all future readings being compared to this baseline. Alternatively, a baseline might be established whenever a new or newly repaired robot is available.

Alternative approaches could allow for the continuous monitoring of the noise levels or monitoring a wider range of noise frequency values, and the automation of the process instead of manually performing steps, for example. One alternative is to modify the analysis software, or replace it with alternative software, or to provide software to interface to the analysis software. This updated functionality would automatically read the wave files (or directly read the analysis software output) and provide the trending results. The threshold could be automatically monitored, with the modified software notifying the operator when wear has become excessive and hence replacement of parts is desirable.

Furthermore, the RAS sensors might be modified for wireless operation, so that no direct cable connection is necessary. Another option is to use an alternative to the inspection and analysis system described above. For example, alternative types of sensors might be utilized (such as by monitoring different emitted frequencies, monitoring temperatures or other parameters, etc.), or a plurality of sensors might be used that could, for example, each monitor different frequency bandwidths; active sensors might be utilized (such as by monitoring reflective waveforms emitted by the sensors or by other transducers); the components of the system might be differently arranged or allocated (for example, the functions of the probe and computer could be combined or differently separated); and alternative analysis systems might be used that evaluate the sensed data (for example, frequency analysis might be utilized rather than focusing on amplitudes, and/or other statistical variables other than averages might be calculated and utilized for trend analysis). Furthermore, different components of the disclosed or alternative systems might be remotely located by utilizing computer, the Internet, or other communication networks to allow the components to communicate to each other.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of maintaining a robot comprising the steps of:
detecting a noise signal emitted by the robot;
recording the detected noise signal on a plurality of different dates;
determining amplitude data of the noise signals recorded on different dates;
comparing the amplitude data of the noise signals recorded on the different dates to each other; and
performing a maintenance operation on the robot as a result of said comparing.

2. The method of claim 1, wherein said step of comparing the amplitude data of the noise signals is performed for noise signals that are at or near a particular ultrasonic frequency.

3. The method of claim 2, wherein said particular ultrasonic frequency is about 30 kHz.

4. The method of claim 1, wherein said recording of the detected noise signal is stored as a way file.

5. The method of claim 1, further comprising the step of, prior to said step of detecting the noise signal, securely attaching an audio sensor to the robot.

6. The method of claim 1, wherein said step of comparing the amplitude data includes the step of monitoring average amplitudes of the noise signals recorded on different dates to each other to detect a difference in the average amplitudes of the noise signals that exceed a predetermined threshold average amplitude, wherein said step of performing the maintenance operation on the robot is performed after detecting the difference in the average amplitudes of the noise signals exceeding the predetermined threshold average amplitude.

7. The method of claim 6, wherein said step of comparing the average amplitudes of the noise signals is performed for noise signals that are at or near a particular ultrasonic frequency.

8. The method of claim 1, wherein the noise signal emitted by the robot includes a noise signal emitted by a reducer of the robot.

9. The method of claim 1, wherein said maintenance operation includes an inspection, repair, or replacement of a part of the robot.

10. The method of claim 1, wherein said step of detecting the noise signal is performed using an audio sensor.

11. The method of claim 10, wherein said step of recording the detected noise signal is performed using an audio analyzer adapted for using said audio sensor, and further wherein the noise signals recorded on different dates are transferred to a computer running analysis software to perform said step of comparing the amplitude data of the noise signals using said computer.

12. A method of maintaining a robot comprising the steps of:
attaching an audio sensor to the robot for detecting a ultrasonic noise signal emitted by the robot;
recording the detected ultrasonic noise signal emitted by the robot on a plurality of different dates;
determining an average amplitude of the ultrasonic noise signals recorded on each of the different dates;
comparing the average amplitudes of the ultrasonic noise signals to each other to detect a predetermined threshold difference between the average amplitudes; and
performing a maintenance operation on the robot as a result of detecting said predetermined threshold difference.

13. The method of claim 12, wherein said step of comparing the average amplitudes is performed for noise signals that are at or near a particular ultrasonic frequency.

14. The method of claim 13, wherein said particular ultrasonic frequency is about 30 kHz.

15. The method of claim 12, wherein the noise signal emitted by the robot includes a noise signal emitted by a reducer of the robot.

16. The method of claim 12, wherein said maintenance operation includes an inspection, repair, or replacement of a part of the robot.

17. The method of claim 12, wherein said predetermined threshold is determined by monitoring the average amplitudes of the noise signals until a critical date at which failure occurs or is about to occur, such that said predetermined threshold is derived from the average amplitudes of the noise signals that were recorded near or at the critical date.

18. A method of maintaining a robot comprising the steps of:
attaching an audio sensor to a reducer of the robot for detecting a noise signal emitted by the reducer;
recording the detected noise signal emitted by the reducer on a plurality of different dates;
determining, using a computer, at least one characteristic of each of the noise signals recorded on the different dates;
comparing, using the computer, the least one characteristic of the noise signals recorded on different dates to each other to detect a predetermined threshold difference in the at least one characteristic; and
performing maintenance on the reducer as a result of detecting said predetermined threshold difference.

19. The method of claim 18, wherein said predetermined threshold is determined by monitoring the at least one characteristic of the noise signals until a critical date at which failure occurs or is about to occur, such that said predetermined threshold is derived from the at least one characteristic of the noise signals that were recorded near or at the critical date.

20. The method of claim 18, wherein said at least one characteristic is an average of the amplitude of the noise signals recorded on the different dates, and wherein the noise signals are at a frequency of about 30 kHz.
